(19) United States
(12) Patent Application Publication
(10) Pub. No.: US 2025/0074067 A1
(43) Pub. Date: Mar. 6, 2025

(54) FLUID DELIVERY SYSTEM

(71) Applicant: ORBOTECH LTD., Yavne (IL)

(72) Inventors: Gaetano ZAPPALA, Gorizia (IT); Paride RUSSO, Udine (IT)

(21) Appl. No.: 18/747,380

(22) Filed: Jun. 18, 2024

(30) Foreign Application Priority Data
Sep. 4, 2023 (IT) 102023000018075

(51) Int. Cl. B41J 2/175; B41J 2/18; B41J 2/195

(52) U.S. Cl. CPC B41J 2/17596; B41J 2/18; B41J 2/195

(57) ABSTRACT

A fluid delivery system for a printer includes a fluid reservoir, an input pump fluidly coupled to the fluid reservoir which is configured to pump fluid from the reservoir to a print head for depositing the fluid onto a printing substrate. The system further includes an output pump that is fluidly coupled to the print head to recirculate the fluid from the print head back to the fluid reservoir and a controller communicatively coupled to at least the input pump which is configured to alter one or more characteristics of the input pump to alter one or more parameters of the fluid delivered to the print head.

### CROSS REFERENCE TO RELATED APPLICATIONS

The present application claims priority to and benefit of IT Application No. 102023000018075, filed Sep. 4, 2023, the entire disclosure of which is incorporated herein by reference.

### FIELD OF THE DISCLOSURE

This present disclosure relates to a fluid delivery system and in particular to an ink delivery system for a printer.

### BACKGROUND OF THE DISCLOSURE

For fluid delivery within printer systems, the fluid comprising of ink to be printed on a printing substrate, the ink path is typically static. In particular the ink flow pathway has a beginning, at an ink reservoir, and an end, at the print head. This fluid flow pathway typically comprises four main components, but only a number of these components have a direct impact on the ink flow pathway performance. For example, a prior art delivery system typically comprises a leveling tank (L-Tank) in which the ink level is set to achieve the set meniscus pressure in the print heads, one or more compensator tanks (C-Tanks) configured to compensate any pressure variation to aid in keeping the print heads meniscus pressure stable and also feed the print head with ink and a main tank which has the largest ink capacity in the machine and supplies the levelling tank when needed and one or more print heads. The print heads in this arrangement are passive elements in the fluid flow pathway with the ink ejected therefrom during printing and cleaning phases. This ink flow pathway accomplishes the three main duties of an ink delivery system including: feeding ink to the print heads without introducing any additional fluid movement resistance; maintaining the meniscus pressure in the print head working window; and providing a cleaning action on the print heads.

In operation, the print heads receive the ink from the compensator tanks, which in turns, get the ink from the levelling tank. The levelling tank uses level sensors to determine its status and further to determine when to refill itself from the main tank. The levelling tank ink level must be at a lower height compared to the print heads nozzle plate as the height difference ensures a negative gauge meniscus pressure to the print head by gravity. The levelling tank ink level can move vertically by a few centimeters to adjust the negative pressure however this has a somewhat limited range, typically in the region of 3 to 4 mbar. During a clean action, the ink from the levelling tank is pushed into the compensator tanks and the print heads to create an overpressure in the levelling tank itself. The ink then flows through the print heads and through an outlet in the compensator tank before reaching the main tank.

However, there are a number of deficiencies with the present flow pathway. For example, because the entire mechanism is static, based on communicating vessels, it is then fundamental that the compensator tank and the levelling tank always maintain the correct ink level. If this last one decreases under the minimum allowed, then the print heads are exposed to the air and the levelling tank cannot act anymore to maintain the negative meniscus pressure, which results in the ink then flowing out of the print heads leaving them empty. Further because of the static nature of the pathway there is no active ink recirculation, the air bubbles absorbed during the printing phase accumulate in the print heads over time. Even during the clean action, the quantity of exchanged ink is low and it cannot ensure the complete removal of the air bubbles. For this reason, a clean action after each print is required and must be performed to maintain the printing quality of the print heads, which means being able to print without missing nozzles or nozzle deviations. Further the meniscus pressure can only be adjusted in a very small range as a result of the static nature of the setup, and only when the printing phase is not occurring. Further because of the number of different components involved in the ink delivery system, the clean action requires a number of sub tasks (valve control, overpressure in levelling tank and external vacuum at a cleaning station) and there exists a very big air lung in levelling tank. All of these factors accumulate to extend the cleaning time, for example typical cleaning times can vary from a minimum of 10 s up to above 20 s depending on the ink type and the complexity of the printer.

The present disclosure addresses the above deficiencies.

### SUMMARY OF THE DISCLOSURE

Embodiments of the present disclosure provide a fluid delivery system for a printer. The fluid delivery system for a printer may include a fluid reservoir, an input pump fluidly coupled to the fluid reservoir which may be configured to pump fluid from the reservoir to a print head for depositing the fluid onto a printing substrate, an output pump that may be fluidly coupled to the print head which may be configured to recirculate the fluid from the print head back to the fluid reservoir, a controller communicatively coupled to at least the input pump which may be configured to alter one or more characteristics of the input pump to alter one or more parameters of the fluid delivered to the print head.

In embodiments of the present disclosure, the input pump may be configured to pump a predetermined volume of fluid from the fluid reservoir to the print head. For example, the input pump may be configured to pump only the predetermined volume of fluid from the fluid reservoir to the print head with each pumping action of the input pump.

Embodiments of the present disclosure may further comprise one or more sensors which may be configured to measure one more parameters of the fluid which may be pumped to the print head.

In embodiments of the present disclosure, the controller may be further communicatively coupled to the output pump and may be configured to alter one or more characteristics of the output pump.

In embodiments of the present disclosure, the one or more sensors may be located downstream of the input pump and upstream of the print head.

In embodiments of the present disclosure, the one or more sensors may be configured to measure pressure, temperature, viscosity and or any other suitable parameter of the fluid.

Embodiments of the present disclosure may further comprise a heating assembly which may be configured to heat the fluid received from the input pump which may be delivered to the print head.

In embodiments of the present disclosure, the input pump and output pump may be each independently controllable.

In embodiments of the present disclosure, the one or more characteristics of the input pump which the controller may be configured to alter include flow rate, pressure or any other suitable characteristic.

In embodiments of the present disclosure, the controller may be configured to alter the predetermined volume and/or pressure of the fluid pumped to the print head based on one or more of the sensor measurements.

In embodiments of the present disclosure, the controller may be configured to alter the predetermined volume of pumped to the print head based on the pressure of the fluid.

In embodiments of the present disclosure, the input pump and output pump may include peristaltic pumps.

In embodiments of the present disclosure, the output pump may be fluidly coupled to a plurality of print heads and/or the fluid reservoir may be fluidly coupled to one or more other fluid supplies and/or the output pump may be configured to maintain a constant flow rate in the system.

Embodiments of the present disclosure further provide a printer including a fluid delivery system described herein.

Embodiments of the present disclosure further provide a method of printing. The method may include pumping fluid from a fluid reservoir to a print head for depositing the fluid onto a printing substrate, printing on the printing substrate, pumping the fluid from the print head back to the fluid reservoir, and altering one or more characteristics of the input pump by a controller to alter one or more parameters of the fluid delivered to the print head.

Embodiments of the present disclosure may further include measuring, by one or more sensors, one of more parameters of the fluid which may be pumped from the fluid reservoir to the print head and wherein altering the one more characteristics of the input pump may be based upon one or more of the measured parameters.

### BRIEF DESCRIPTION OF THE FIGURES

The application will now be described by way of example with reference to the accompanying drawings in which:

FIG. 1 is a diagram illustrating a fluid delivery system for a printer embodying a first aspect of the present disclosure;

FIG. 2 is a fluid schematic of the fluid delivery system for a printer;

FIG. 3 is a perspective view of a fluid reservoir;

FIG. 4 is a perspective view of a heating assembly;

FIG. 5 is a perspective view of a pump, in particular showing a peristaltic pump;

FIG. 6 is a front perspective view of a print head;

FIG. 7 is a front plan view of the print head;

FIG. 8 is a bottom plan view of the print head;

FIG. 9 is a further bottom plan view of the print head in particular showing the print head nozzles;

FIG. 10 is a perspective view of a printer comprising the fluid delivery system which embodies a second aspect of the present disclosure;

FIG. 11 is a diagram illustrating a change in pressure over time which occurs during a cleaning phase of a printer comprising the fluid delivery system of the present disclosure;

FIG. 12 is a diagram illustrating the rise time in the change in pressure which occurs during a cleaning phase of a printer comprising the fluid delivery system of the present disclosure;

FIG. 13 is a diagram illustrating the fall time in the change in pressure which occurs during a cleaning phase of a printer comprising the fluid delivery system of the present disclosure;

FIG. 14 is a diagram illustrating the change of ink viscosity over time; and

FIG. 15 is a diagram illustrating the variation in pressure over time within the fluid delivery system.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

The steps of the method described in the various embodiments and examples disclosed herein are sufficient to carry out the methods of the present disclosure. Thus, in an embodiment, the method consists essentially of a combination of the steps of the methods disclosed herein. In another embodiment, the method consists of such steps.

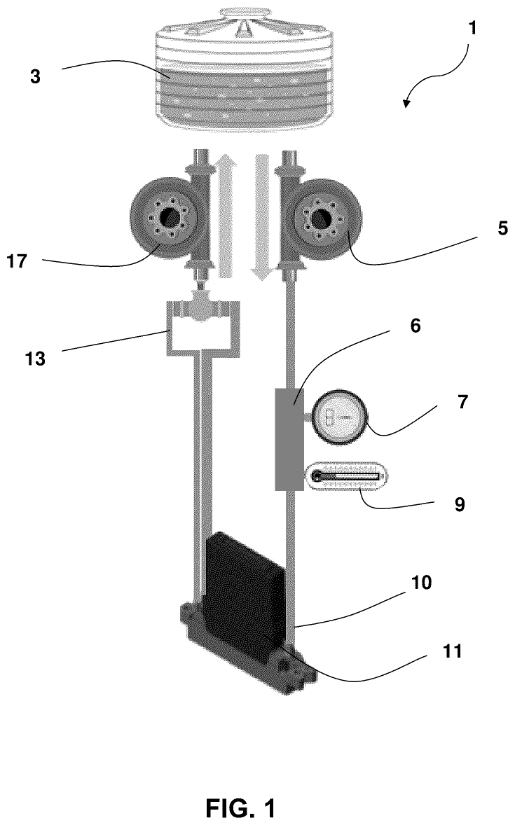

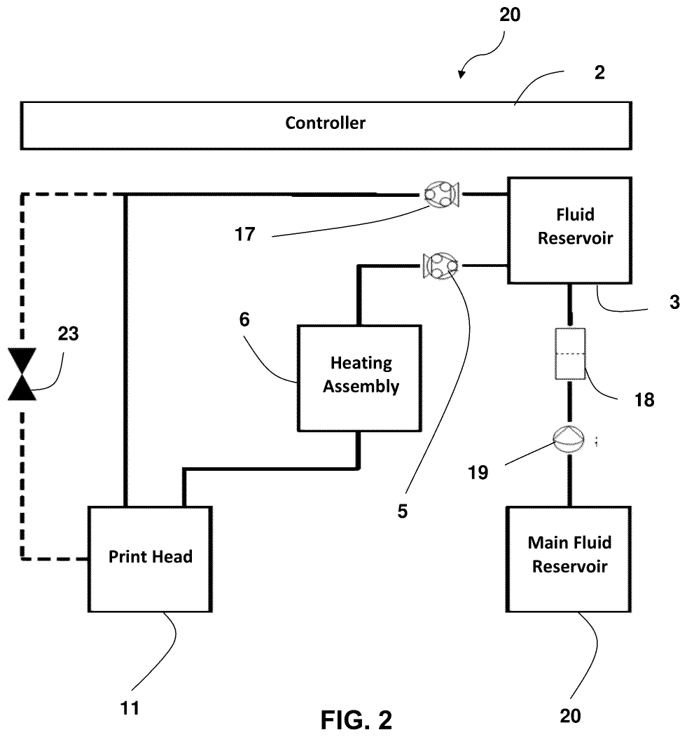

Referring now to the drawings, in particular FIGS. 1 and 2, there is shown, generally indicated by the reference numeral 1, a fluid delivery system for a printer which embodies a first aspect of the present disclosure. The fluid delivery system 1 comprises a fluid reservoir 3, an input pump 5 fluidly coupled to the fluid reservoir 3 which is configured to pump fluid from the fluid reservoir 3 to a print head 11 for depositing the fluid onto a printing substrate (not shown). To this end the input pump 5 is fluidly coupled to the print head 11, in particular to an input 10 thereof. The system 1 further comprises an output pump 17 that is fluidly coupled to the print head 11, in particular an output 13 thereof, which is configured to pump the fluid from the print head 11 back to the fluid reservoir 3. The output pump 17 may be coupled to multiple print heads 11. The fluid which is pumped back from the print head 11 by the output pump 17 may comprise, fluid remaining after printing has occurred or it may be recirculation of the fluid pumped from the input pump 5. Further, the system 1 comprises a controller 2 which is communicatively coupled to at least the input pump 5 and preferably the output pump 17 and which is configured to alter one or more characteristics of the input pump 5 and output pump 17 to alter one or more parameters of the fluid being pumped by the respective pumps. Wherein the controller 2 is configured to alter one or more characteristics of the input pump 5 to in turn alter one or more parameters of the fluid delivered to the print head 11. The fluid flow from the fluid reservoir 3, through the input pump 5, print head 11, and output pump 17 back to the fluid reservoir 3 defines a fluid flow pathway. A key feature of the present disclosure is that, in comparison to the prior art mentioned, the print heads 11 are not the last stage in the fluid flow pathway defined by the components of the present disclosure as the ink flows through the print head 11 and is then recirculated back to the fluid reservoir 3. Advantageously, the closed loop nature of the fluid flow pathway provided by the fluid delivery system 1 allows for better fluid pressure management and aids in preventing air bubbles being absorbed during the printing phase, improving the printhead jetting reliability and printing quality.

The fluid comprises ink such that the fluid reservoir 3 comprises a supply of ink. The fluid delivery system 1 may further comprise a main fluid reservoir 20 (such as shown in FIG. 2) which is fluidly coupled to the fluid reservoir 3 and from which the fluid reservoir 3 may be supplied fluid. To this end the fluid reservoir 3 is typically smaller in capacity than the main fluid reservoir 20. The system 1 may comprise a plurality of print heads 11, to this end each print head 11 is fluidly coupled to a respective input pump 5 such that each print head 11 ideally has its own associated input pump 11. However, the output 13 of a plurality of print heads 11 may be coupled to the same output pump 17 as there is less variation required in the parameters of the fluid output from the print heads 11 as this is typically merely being pumped back to the fluid reservoir 3. It should be understood that the various components of the system 1 are fluidly coupled by tubing, typically flexible tubing which fluidly couples the various components for fluid flow.

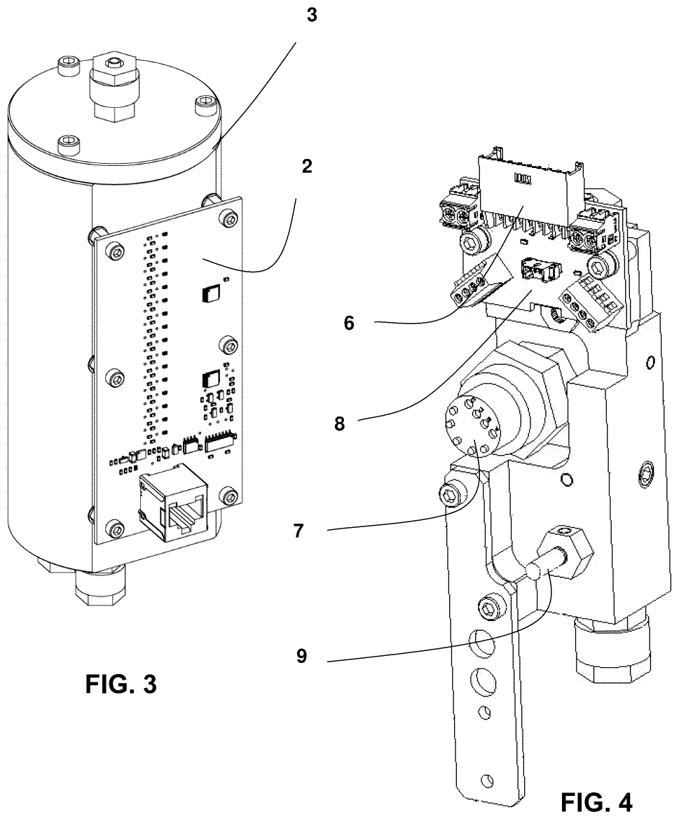

FIG. 3 shows an example of the fluid reservoir 3. In the example shown the fluid reservoir 3 is substantially cylindrically shaped however this should not be construed as limiting, the fluid reservoir may have any suitable shape. The fluid reservoir 3, as mentioned previously, is typically fluidly coupled to the main fluid reservoir 20 for receiving fluid supply (see FIG. 2). To this end the system 1 further comprises a reservoir pump 19 which is configured to pump fluid from the main fluid reservoir 20 to the fluid reservoir 3. The reservoir pump 19 typically comprises a diaphragm pump, however it may comprise any other suitable pump. The system 1 may also comprise one or more fluid filters 18 which are ideally disposed in the fluid flow path between the main fluid reservoir 20 and the fluid reservoir 3 such that fluid supplied from the main fluid reservoir 20 is filtered prior to entering the fluid reservoir 3. The fluid reservoir 3 may comprise one or more reservoir sensors (not shown) which are configured to monitor the fluid contained therein, for example the reservoir sensors may comprise a level sensor, temperature sensor and/or pressure sensor or one or more other sensors. The reservoir sensors may be communicatively coupled to the controller 2 and/or the fluid reservoir 3 may further comprise a reservoir controller, which is coupled or otherwise mounted to the fluid reservoir 3, to which the reservoir sensors are communicatively coupled to. The reservoir controller may be communicatively coupled to the other elements of the system 1 including but not limited to the input and/or output pump 5, 17, the print head(s) 11 and/or a heating assembly 6. The reservoir sensor(s) are communicatively coupled to the controller 2 and/or the reservoir controller such that, for example, wherein the reservoir sensor comprises a level sensor and the level of fluid contained within the fluid reservoir 3 falls below a predetermined level, the controller 2/reservoir controller is configured to pump fluid from the main fluid reservoir 20 the fluid reservoir 3.

The input pump 5 is configured to pump only a predetermined volume of fluid from the fluid reservoir 3 to the print head 11 with each pumping action. This ensures that only the desired volume of fluid is pumped with each pumping action and which, as a result of the circulation within the fluid flow pathway at a determined pressure, ensures that no air is introduced into the fluid flow pathway. This volume may vary depending on the particular requirements of the printing action to occur and/or the type of printing substrate to which the printing will be applied. For example, the input pump 5 may be configured to pump only the predetermined volume of fluid from the fluid reservoir to the print head with each pulsation of the pump. The input pump 5 is further configured to alter one or more parameters of the fluid being pumped by altering one or more operating characteristics of the pump itself. The system 1 preferably comprises one or more sensors 7, 9 which are configured to measure one more parameters of the fluid which is pumped to the print head 11 from the fluid reservoir 3. To this end, the one or more sensors 7, 9 are ideally located downstream of the input pump 5 and upstream of the print head 11 such that the sensors are able to measure the one or more parameters of the fluid prior to it being received at the print head 11. Additionally or alternatively, one or more sensors may be located downstream of the print head 11 which are configured to measure one or more parameters of the fluid which is pumped from the print head 11. The one or more sensors 7, 9 are communicatively coupled to the controller 2 such that the controller can alter the one or more characteristics of the input pump to alter one or more parameters of the fluid delivered to the print head based on the measurements received therefrom. The one or more sensors 7, 9 are configured to measure one or more of pressure, temperature, viscosity and or any other suitable parameter of the fluid. In the embodiment shown in FIG. 1, the system 1 comprises a pressure sensor 7 and a temperature sensor 9, however as mentioned the system 1 may comprise one or more other sensors which are configured to measure one or more other parameters.

Advantageously, the closed loop nature of the fluid flow pathway in combination maintain a constant pressure is configured to ensure that the ink is circulated within the fluid flow pathway without allowing air to be introduced into the fluid circuit. This means that the ink, within the fluid flow pathway, is never in contact with air in any part of the pathway between the input pump 5 and the output pump 17. This has a number of advantages in terms of maintaining printhead jetting reliability, as air causes ink to dry out blocking said jetting, which in turn ensures consistent printing quality.

The system 1 may further comprise the heating assembly 6 which is configured to heat the fluid received from the input pump 5 which is delivered to the print head 11. The heating assembly 6 is typically configured to heat the fluid to a desired temperature, typically pre-determined, such that the fluid received at the print head 11 for printing is at that particular temperature. The heating assembly 6 is communicatively coupled to the controller 2 or additionally or alternatively the heating assembly 6 may comprise a heating controller 8 to which it is communicatively coupled. The one or more sensors 7, 9 may also be communicatively coupled to the heating controller 8 in addition to or alternatively to the controller 2. Further, such as shown in FIG. 1 for example, the one more sensors 7, 9 may be provided as a single integrated unit along with the heating assembly 6. Accordingly, the temperature to which the heating assembly 6 is configured to heat the fluid flowing threrethrough may be altered based on one or more of the measurements acquired by the one or more sensors 7, 9 and in particular a temperature sensor 7. For example, the temperature sensor 9 may indicate that the temperature of the predetermined volume of fluid which has been received from the input pump 5 does not meet a desired value, for example if the temperature is too low, the heating assembly 6 is configured to heat the volume to the desired temperature prior to it exiting the heating assembly 6 for receiving at the print head 11. Additionally or alternatively, if the temperature sensor 9 indicates that the temperature of the volume of fluid is too low, subsequent volumes of fluid to that which was measured may be heated to the desired temperature.

FIG. 4 illustrates an example of the heating assembly 6. The heating assembly 6 comprises an assembly body and further comprises a pressure sensor 7 and a temperature sensor 9. The heating assembly 6 is ideally communicatively coupled to the controller 2 which may be configured to alter the operating state or the temperature to which the heating assembly 6 is configured to heat fluid passing there through based on one or more measurements acquired by the sensors 7, 9. Additionally or alternatively, the heating controller 8 may be configured in a similar manner.

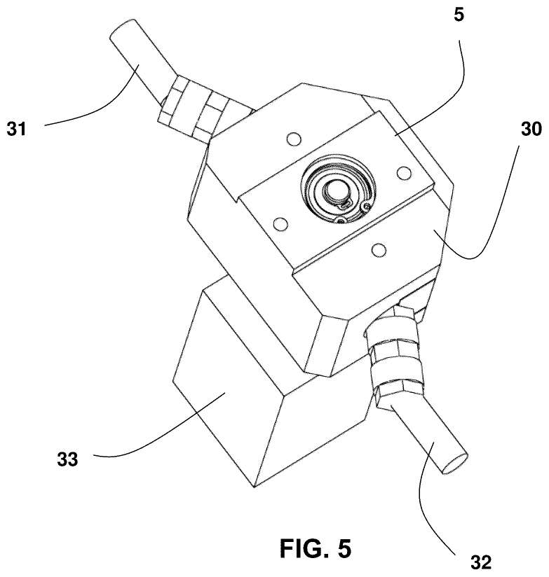

The input pump 5 and output pump 17 are each independently controllable by the controller 2 to which they are communicatively coupled. Additionally or alternatively each of the input and output pumps 5 may comprise their own respective controllers. The characteristics of the input pump 5 and output pump 17 may be different with respect to one another as is dictated by the requirements of the system 1. The one or more characteristics of the pumps 5, 17 which the controller is configured to alter include flow rate, pressure, motor speed or any other suitable characteristic. As mentioned previously, the controller 2 is configured to alter the predetermined volume of fluid pumped to the print head 11 based on the one or more of the sensor 7, 9 measurements. In particular, the controller 1 is preferably configured to alter the predetermined volume of fluid pumped to the print head 11 based at least on the measured pressure of the fluid, this being acquired by the pressure sensor 9. The input pump 5 and/or output pump 17 typically comprise peristaltic pumps such as shown in FIGS. 1 and 5 however it should be understood that the input pump 5 and/or output pump 17 may comprise any suitable pump which is operable to provide the predetermined volume of fluid to the fluid flow pathway and also to stop fluid moving within the system 1. For example the input pump 5 and/or output pump 17 may comprise any other suitable positive displacement pump. The fluid flow path may further comprise one or more valves 23 which are configured to prevent or allow the movement of fluid between the respective elements of the system 1.

FIG. 5 illustrates the input pump 5 however it should be understood that the foregoing description is equally applicable in respect of the output pump 17. The input pump 5 comprises a peristaltic pump comprising a pump body 30, an input 31 for receiving the fluid therein and an output 32 for outputting the fluid. The pump further comprises a motor 33 which is configured to drive the pump. The input and output pumps 5, 17 may be configured to run continuously, or they may be indexed through partial revolutions to deliver smaller predetermined volumes of fluid.

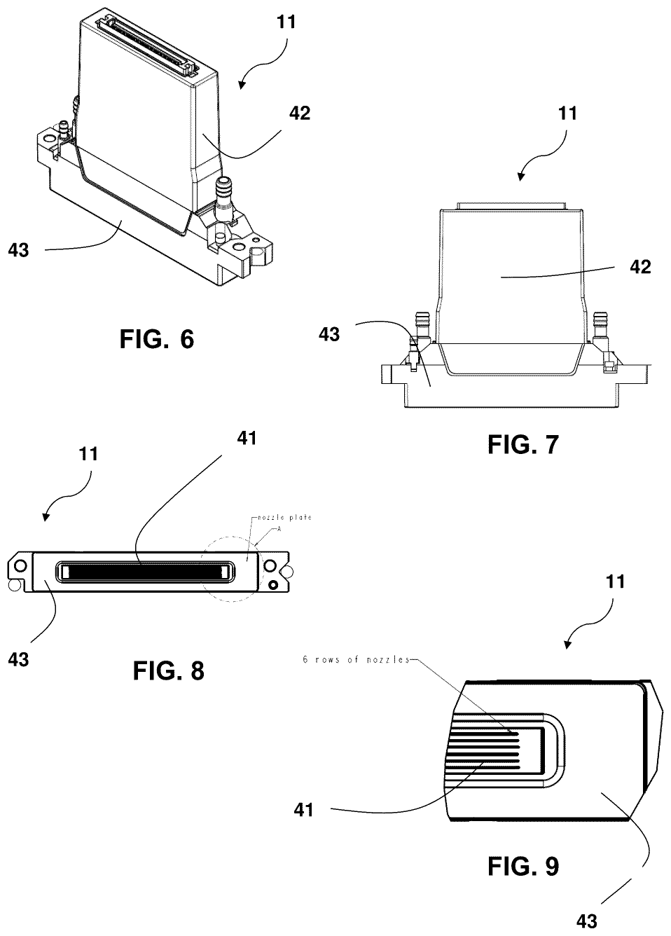

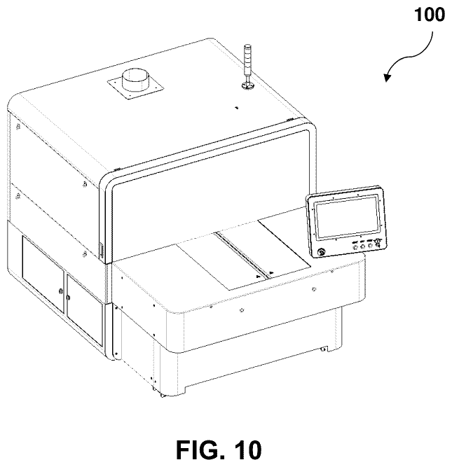

FIGS. 6 to 9 illustrate the print head generally indicated by the reference numeral 11. However, it should be understood that the fluid delivery system 1 is compatible with a variety of print heads, and the one shown in FIGS. 6 to 9 is for illustrative purposes. The print head 11 typically comprises a container 42 for ink supply, which is typically substantially cuboidal in shape which substantially defines the print head body. The container 42 is configured for coupling to a print head assembly at one end and a nozzle plate 43 at the opposing end. The nozzle plate 43 being removably coupled to the container 42. The nozzle plate 43 comprises the plurality of print head nozzles 41 through which ink may be ejected in-use. The print head 11 may comprise one more sensors, for example the sensors may comprise a level sensor which is configured to measure the level of the fluid contained therein.

FIG. 10 illustrates a printer 100 comprising the fluid delivery system 1 previously described. The printer 100 typically comprises an inkjet printer. Further to the fluid delivery system 1, the printer 100 typically also ideally comprises a substrate support device. The substrate support device is configured to support a printing substrate during the printing process. To this end the substrate support device typically comprises a stage or chuck or any other suitable means suitable for retaining the substrate thereon. The printer 100 may comprise a plurality of fluid delivery systems 1 included therein. The printer 100 is configured to apply a pattern onto the printing substrate in use. Advantageously, the fluid flow pathway provided by the system 1 is based on active flow recirculation, the print heads 11 are not the last stage of the fluid flow pathway as is the case in the prior art, because the fluid flows through the print head 11 and comes back to the fluid reservoir 3.

In-use, example operation of the system 1 is as follows. The input and output pumps 5, 17 comprising peristaltic pumps are configured to rotate in opposite directions and put the fluid reservoir 3 in fluid communication with the print head 11. Initially the fluid, comprising ink, is pumped from the fluid reservoir 3 by the input pump 5 towards the print head 11. However, prior to entering the print head 11 the ink ideally passes through a heating stage where the fluid travels through the heating assembly 6 which is configured to heat the ink to a pre-defined temperature, the heating assembly 6 further comprising the pressure sensor 7 and the temperature sensor 9. Preferably, the output pump 17 is set at a fixed motor speed to provide a desired flow rate. In contrast, ideally the input pump 5 motor speed is determined based on one or more measurements acquired by the pressure sensor to obtain a desired constant flow rate and ink pressure

At the heating stage, where the ink passes through the heating assembly 6, the temperature sensor 9 is configured to continuously monitor the ink temperature to drive the heating assembly 6 to achieve the required ink temperature for ink exiting the heating assembly 6. Typically as mentioned previously each fluid reservoir 3 comprises its own respective reservoir controller which is coupled to a level sensor which is configured to monitor the ink level within the reservoir and refill it when required from the main fluid reservoir 20. The reservoir controller may also be typically configured to estimate the peristaltic pump and/or pump tube performances and may be configured to determine when the pump and/or pump tubing require replacement. Additionally or alternatively the controller 2 may perform this function.

In-use the printer 100 is typically configured to adopt three different phases, an idle phase where the printer is not printing or cleaning, a printing phase where it is configured to print upon a printing substrate and a cleaning phase where the printer 100 is configured to clean the printheads 11, in particular the nozzles 41 thereof to ensure accurate ink ejection.

When the printer 100 is configured to adopt a printing phase, where it is configured to print upon a printing substrate, the input pump 5 is configured to pump ink to the print head 11 and to keep the pressure constant there through, to this end the motor 33 of the input pump 5 is configured to vary its rpm to compensate for pressure variations of the ink supplied to the print head 11. The output pump 17 is configured to maintain a constant flow rate such that the output pump 17 typically has a fixed rpm value.

When not in the printing phase or the cleaning phase i.e. in the idle phase, the rpm of the input pump 5 is varied to maintain a constant pressure and the rpm of the output pump 17 is kept substantially constant to maintain the flow rate. When the printer 100 is configured to adopt the cleaning phase, the output pump 17 is configured to stop pumping whilst the input pump 5 is configured to increases its rpm relative to that at the idle phase, such as to supply a very high flow rate of ink to the print head 11 to allow for ink to flow through the nozzle plate to clean the nozzles. The output pump 17 is only configured to stop pumping for a short period of time, typically comprising less than Is, whilst the input pump 5 continues to pump. After the period of time has elapsed the output pump 17 is configured to restart its pumping action and the input pump 5 is then configured to stop pumping. This allows the print head 11 to suck the majority of the ink pumped from the input pump 5, thereby wetting the nozzle plate 43. After a few seconds have elapsed, the input pump 5 is then configured to restart and adopt its normal idle rpm. The cleaning phase may also involve an external vacuum or wipe action to clean the print head 11 from residual ink.

Maintaining accurate meniscus pressure within the print head 11 is critical to ensuring optimum printing by the printer 100 as this reduces the occurrence of defects during printing. When the meniscus pressure is too low it can lead to air ingestion and ink starvation whilst if the pressure is too high the nozzle plate can become flooded with ink, compromising the quality of printing. In the system 1 and consequently the printer 100, the print head 11 meniscus pressure is determined by the input pump 5. When the rpm of the input pump 5 is greater than that of the output pump 17, the fluid flow path pressure increases and consequently so does the print head 11 meniscus pressure. The present disclosure has the ability to vary the meniscus pressure in a wide range, typically from around −200 mBar to 1000 mBar. This enables the system to adapt to a variety of different print heads with different technical specifications and enables the system to adapt to perform a number of different actions including idling, printing and cleaning.

In comparison to the prior art, the system 1 is more space efficient as it removes the need for levelling and compensator ink reservoir tanks. Further the fluid reservoir tank 3, having only the objective to feed ink to the print heads 11, has a very simple mechanical design. As each component part typically comprises its own controller for operation of that part it provides an easy to maintain robust system. Further the use of the input pump to provide only a predetermined volume of fluid ensures that there is no air lung in the circuit, consequently the print heads 11, in particular the fluid flow pathway flowing therethrough, are never in direct contact with air and therefore cannot lose their meniscus pressure without a tube break. Further advantageously, because the meniscus pressure of the print head 11 is calculated from a direct measurement, i.e. by the measurements acquired by the pressure sensor 7, not just estimated from height difference as is the case in the prior art, it provides better control with enhanced granularity as there is the potential to adjust it across a much larger range. Further advantageously, the system is more reactive due to the lack of an air lung in the fluid flow pathway which delays pressure propagation in prior art systems. Accordingly, the present disclosure is able to rapidly compensate for pressure changes which occur during the different phases of printer operation. Also, due to the absence of air in the fluid flow pathway, degradation of ink viscosity happens at a much slower rate as it is moisture within air which leads to oxidation of ink reducing the viscosity. By removing the air lung this effect is mitigated. Further, as a result of the closed loop feedback control provided by the combination of pressure sensor and controller, the system is much more active it is not a passive system where the pressure will fluctuate about a value with no control as in the present disclosure pressure changes will be measured and the input pump will be configured accordingly to compensate for said changes.

Further advantageously, as the heating assembly 6 is separate element in the fluid flow pathway, the heating assembly 6 is configured to only directly increase the temperature of the fluid, in particular ink, which passes there through. The print head 11 is not heated directly itself such that the expected temperature difference between the print head 11 and the ink temperature itself will be lower and the print head 11 will have a more uniform temperature distribution, resulting in an improved printing quality. Additionally, the active flow recirculation will aid in continuous removal of any absorbed air bubbles during the printing phase, improving the jetting reliability and printing quality. The cleaning phase of the print head 11, as performed with specific pump actions as described previously, is much faster than the prior art with a very strict control on timing and pressure, it also provides for the possibility of neglecting the external vacuum or wipe action to clean the print head 11 from residual ink due its effectiveness in practice. This improvement lowers the complexity of the overall system and makes it cheaper as the vacuuming/wiping is not essential.

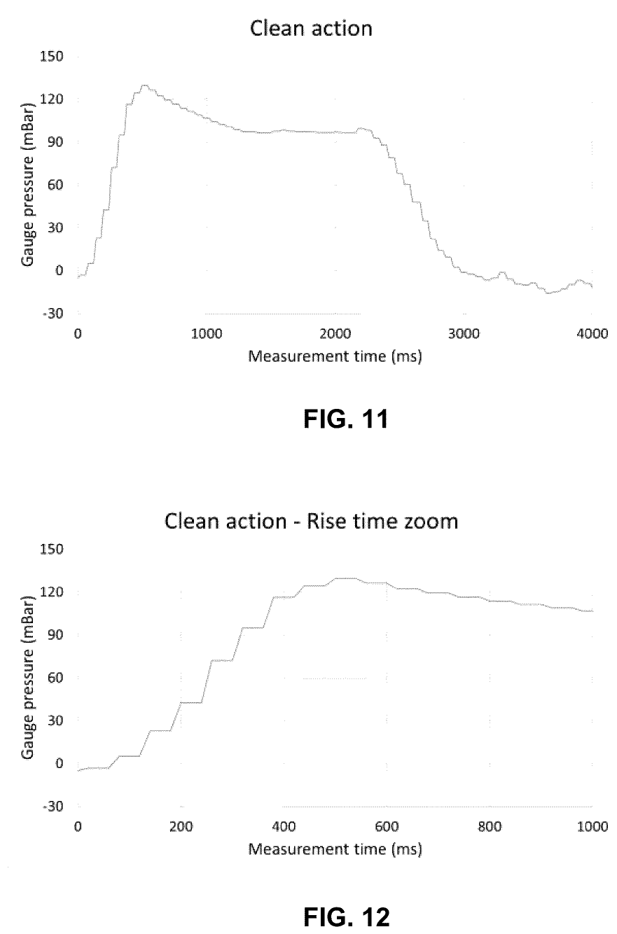

Referring now to FIGS. 11 to 13 there are shown diagrams illustrating the change in pressure over time during a cleaning phase of a printer comprising the fluid delivery system 1. As mentioned previously, a key feature of the present disclosure is that the ink within the fluid flow pathway is never in contact with the air in any part of the pathway between the input pump 5 and the output pump 17. As a result of this, the pressure variation, induced by the pumps 5, 17 in the fluid flow pathway propagates at the speed of sound within the ink (due to the similarity of physical properties between water and ink) and consequently this variation occurs almost instantaneously. This is applicable for fluid flow pathways or circuits measuring from tens of centimetres up to several meters in length. As a result of this pressure variation, it is possible to vary the pressure within the fluid flow pathway even in the order of tens of mBar in a very brief time, typically less than a second.

This rapid system response is very important during the operation of print head cleaning, as the cleaning operation requires the pressure in the fluid flow pathway to be increased above a certain predetermined value to remove ink drops from the print head and subsequently, after a short period of time, restore the previous normal circuit pressure i.e. the pressure within the fluid flow pathway prior to the initiation of the cleaning phase. This action directly impacts on the printer throughput because during the time taken for the printer to undergo the cleaning phase no printing is possible. In the present disclosure the presence of the air in the fluid flow pathway is prevented such that the cleaning phase can be performed extremely fast. This is in contrast to prior art system which are much slower as they allow for air to be introduced into the fluid flow pathway and when air is present in the pathway it essentially operates almost like a spring, absorbing the pressure variations and propagating them much slower.

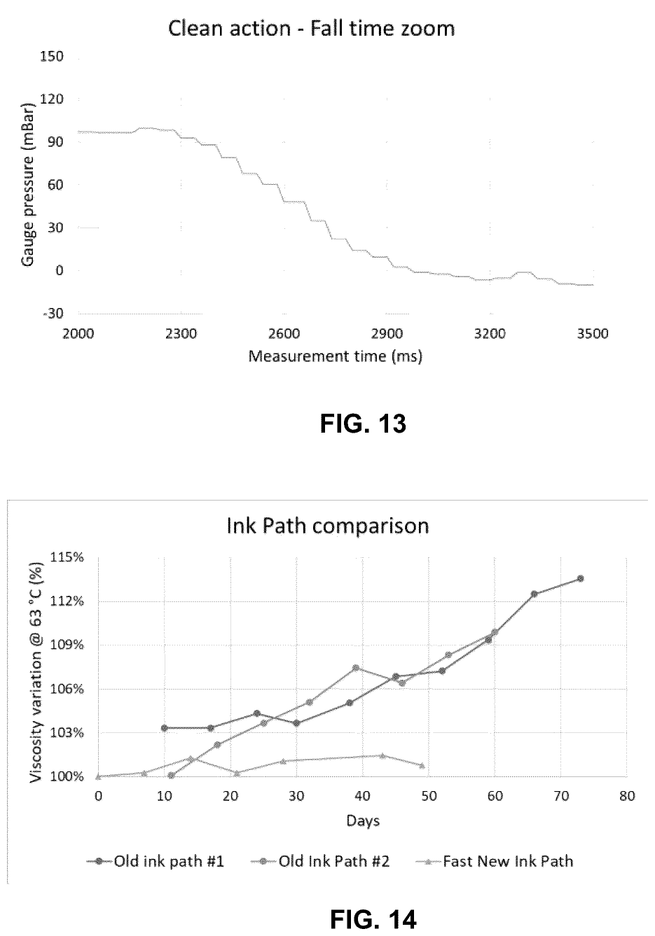

FIG. 11 is a diagram illustrating the change in pressure over time during the cleaning phase of a printer comprising the fluid delivery system of the present disclosure. FIGS. 12 and 13 illustrate the rise and fall times of the pressure respectively in more detail than that shown in FIG. 11. FIGS. 11 to 13 illustrate an example of how the rise time of the pressure during the cleaning phase can be less than 0.5 sec and the fall time can be lower than 1.0 s. Further, ss can be seen in FIG. 11 the pressure rises significantly upon initiation of the cleaning phase, reaching a peak pressure of around 130 mBar within approximately 500 ms. The entire cleaning phase taking less than 4000 ms. This rapid cleaning phase only being capable because of the features of the present disclosure.

FIG. 14 is a diagram illustrating the change of ink viscosity over time, in particular comparing the ink fluid flow pathway (Fast New Ink Path) of the present disclosure in comparison to prior art arrangements (Old Ink Path #1 and Old Ink Path #2). From experience and measurements obtained using previous printing systems, it is evident that the ink viscosity varies over time. This variation in viscosity is amplified if the ink within a printer is in direct contact with air at higher pressure than typical environment pressure, e.g. high humidity. This effect is mainly a result of air humidity as humid air when trapped within the ink causes oxidation due to the moisture contained therein. During the print head cleaning phase, the pressure within the fluid flow pathway is always increased above the environmental pressure as mentioned in relation to the description of FIGS. 11 to 13, such that if air is present within the fluid flow pathway, and is circulated at higher pressure this accelerates the ink ageing phenomenon. As the ink viscosity varies over time to the extent that the viscosity significantly differs from its initial value, it is necessary to refresh the ink by introducing a volume of new ink into the fluid flow pathway, or by replacing the ink entirely, thus causing a potential loss in terms of time and material consumed for the customer. The present disclosure obviates this problem again by the prevention of air into the fluid flow pathway. This is well illustrated in FIG. 14 where the viscosity of the ink within the fluid delivery system of the present disclosure does not vary significantly over time in comparison to the prior art arrangements.

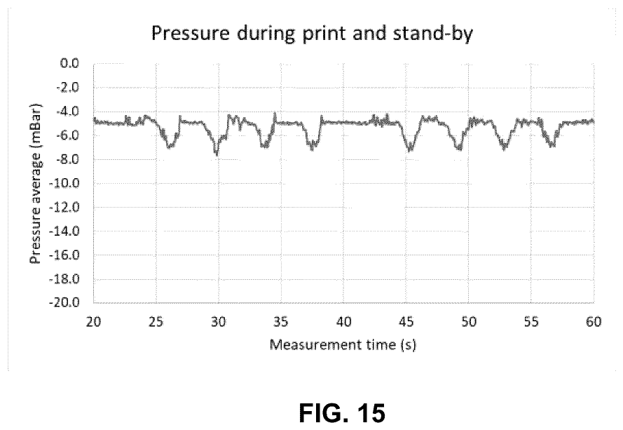

FIG. 15 is a diagram illustrating the variation in pressure over time within the fluid delivery system, in particular during different states including a stand-by phase and the printing phase. During the printing phase, the print head requires ink from the fluid flow pathway causing a meniscus pressure reduction. Without air in the circuit, the pressure sensor 7 becomes aware of the variation almost immediately and the system 1 can compensate the pressure drop in a very short time. In practice, the pressure sensor 7 will measure the pressure within the fluid, with the measured pressure value being provided to the controller 2 which is then configured to alter one or more characteristics of the input pump 5 and typically the output pump 17 to alter the pressure of the fluid. This closed loop feedback control provides a significant benefit in that it provides an almost instant response such that the print head in-use is printing with an almost constant pressure, only varying by a few mBar around the set target. FIG. 15 illustrates the minimal variation of pressure provided by the present disclosure, for example from testing the maximum pressure drop that was obtained was about 3 mBar such as is shown in FIG. 15. Consequently, the pressure is quite stable even when the print head is working at high ink flow rates.

In prior art ink path circuits/fluid flow pathways, in particular those in which the meniscus pressure is ensured by gravity, the ink is in direct contact with air and there is then a delay effect on the pressure variation propagation because the air acts as a spring, as detailed previously. In these type of systems, the print head is subjected to a much more variable meniscus pressure during the printing phase due to the presence of air and the deficiencies caused thereby. In particular, in such systems, the pressure continues to decrease until the volume of air expands to the extent such that to return to its original volume, the system requires new ink to be supplied to the circuit. This also causes the meniscus pressure to also return to the desired set value. The time it takes for the expansion and subsequent contraction of the air volumes are typically different and not directly controllable by the user as these are “passive actions” of the system. A similar behavior is observed in systems in which the meniscus pressure is maintained by controlling, through an air pump, the air pressure on an ink tank. In this scenario, there is an active compensation of the meniscus pressure variations, but again there is also a delay caused by the air volume expansion and subsequent contraction. As the present disclosure prevents air from being introduced into the fluid flow pathway in the first place it and maintains a substantially constant pressure it overcomes the aforementioned deficiencies.

The present disclosure also provides a method of printing using the fluid delivery system 1, the method including:
Pumping fluid from a fluid reservoir 3 to a print head 11 for depositing the fluid onto a printing substrate using an input pump;
Printing on the printing substrate;
Pumping the fluid from the print head 11 back to the fluid reservoir 3 using an output pump; and
Altering one or more characteristics of the input pump 5 by a controller 2 to alter one or more parameters of the fluid delivered to the print head 11.

The method may further include measuring, by one or more sensors 7, 9, one of more parameters of the fluid which is pumped from the fluid reservoir 3 to the print head 11 and wherein altering the one more characteristics of the input pump 5 is based upon one or more of the measured parameters.

Although the present disclosure has been described with respect to one or more particular embodiments and/or examples, it will be understood that other embodiments and/or examples of the present disclosure may be made without departing from the scope of the present disclosure.

1. A fluid delivery system for a printer comprising:
a fluid reservoir;
an input pump fluidly coupled to the fluid reservoir which is configured to pump fluid from the fluid reservoir to a print head for depositing the fluid onto a printing substrate;
an output pump that is fluidly coupled to the print head which is configured to pump the fluid from the print head back to the fluid reservoir; and
a controller communicatively coupled to at least the input pump which is configured to alter one or more characteristics of the input pump to alter one or more parameters of the fluid delivered to the print head.

2. The fluid delivery system of claim 1, wherein the input pump is configured to pump a predetermined volume of fluid from the fluid reservoir to the print head.

3. The fluid delivery system of claim 2, further comprising one or more sensors which are configured to measure one more parameters of the fluid which is pumped to the print head.

4. The fluid delivery system of claim 3, wherein the one or more sensors are located downstream of the input pump and upstream of the print head.

5. The fluid delivery system of claim 3, wherein the one or more parameters of the fluid which the one or more sensors are configured to measure comprise one or more of pressure, temperature, viscosity and or any other suitable parameter of the fluid.

6. The fluid delivery system of claim 1, further comprising a heating assembly which is configured to heat the fluid received from the input pump which is delivered to the print head.

7. The fluid delivery system of claim 1, wherein the input pump and the output pump are each independently controllable.

8. The fluid delivery system of claim 1, wherein the one or more characteristics of the input pump which the controller is configured to alter include flow rate, pressure, or any other suitable characteristic.

9. The fluid delivery system of claim 3, wherein the controller is configured to alter the predetermined volume of fluid pumped to the print head based on the measurements of the one or more sensors.

10. The fluid delivery system of claim 9, wherein the controller is configured to alter the predetermined volume of fluid pumped to the print head based on a pressure of the fluid.

11. The fluid delivery system of claim 1, wherein the input pump and the output pump comprise peristaltic pumps.

12. The fluid delivery system of claim 1, wherein the output pump is fluidly coupled to a plurality of print heads; and/or wherein the fluid reservoir is fluidly coupled to one or more other fluid supplies; and/or wherein the output pump is configured to maintain a constant flow rate in the fluid delivery system.

13. A printer comprising the fluid delivery system as recited in claim 1.

14. A method of printing comprising:
pumping fluid from a fluid reservoir to a print head for depositing the fluid onto a printing substrate;
printing on the printing substrate;
pumping the fluid from the print head back to the fluid reservoir; and
altering one or more characteristics of an input pump by a controller to alter one or more parameters of the fluid delivered to the print head.

15. The method of claim 14, further comprising measuring, by one or more sensors, the one or more parameters of the fluid which is pumped from the fluid reservoir to the print head, and wherein altering the one or more characteristics of the input pump is based upon one or more of the measured parameters.
